(19) United States
(12) Patent Application Publication
(10) Pub. No.: US 2017/0318793 A1
(43) Pub. Date: Nov. 9, 2017

(54) berley container

(71) Applicant: Daniel Aaron ZAGAR, Gilmore (AU)

(72) Inventor: Daniel Aaron ZAGAR, Gilmore (AU)

(21) Appl. No.: 15/585,214

(22) Filed: May 3, 2017

(30) Foreign Application Priority Data
May 3, 2016 (AU) 2016202820

(51) Int. Cl. A01K 97/02; A01K 97/04

(52) U.S. Cl. CPC A01K 97/02; A01K 97/045

(57) ABSTRACT

A berley dispenser (8) has a berley storage volume (10) and a dispenser (42) that communicates the berley storage volume (10) with the outside environment via at least one flow path (44) wherein the dispenser (8) is selectively operable to cause at least one of opening of the at least one flow path (44), closing of the at least one flow path (44), and flow of berley along the at least one flow path (44) from the berley storage volume (10) to the outside environment.

### FIELD OF INVENTION

This invention relates to fishing and berley/fish attractant containers and more particularly to berley containers for dispensing berley into the water

### BACKGROUND

It is common for people when fishing to dispense some form of fish attractant into the water to attract fish and increase the likelihood that fish will be caught.

It is common for berley to be prepared by the angler utilising fish or bait that is then chopped or mashed up into small particles which are then dispensed into the water. Many individuals utilise a simple bucket and a mashing device to break the large pieces of fish or other material into smaller pieces. The resulting mixture can be considered to have an unpleasant odour time consuming and labour intensive. Dispensing of the resultant mix involves pouring or ladling some of the contents of the container into the water, which can result in spillage, under dosing (possibly resulting in reduces effectiveness) or overdosing (possibly resulting in wasted berley and wasting fish resources).

It is believed that having smaller pieces of attractant reduces the mass of berley that needs to be distributed into the water for the same affect; manual mashing can produce a significant variability in the size of pieces produced with subsequently unnecessarily large pieces, again leading to wasted berley Australian patent specification number 2008901197 discloses a berley container that includes motor driven blades that mash berley into smaller particles without the need for manual mashing. The container has an upper inlet through which berley is fed, cutter within the container and at least one opening to allow flow into or out of the container. In use the container is placed in the water with the openings below the water surface, such that water can flow into the container, mix with berley within and subsequently exit via the openings. There is no control over flow of water into or out of the container and consequently no control over the dispensing of berley into the water. The Dosage rate may be too low or too high. It appears that the device of 2008901197 will empty a significant portion of its contents when withdrawn from the water. As such, if fishing from a boat, movement of the boat through the water will affect the dosage rate and also cause loss of berley into the water if moving between fishing locations, unless the container is withdrawn from the water, which results in discharge of the foul smelling berley onto or into the boat. Also mechanical parts are constantly submerged below water level therefore causing a reduced lifespan of the product.

Accordingly, there is a need for a device that provides the user with more control over the dispensing of berley and, optionally, allows a container with a berley mixture within to be stored without significant loss of the berley within and provide easily cleanable, storable and long lasting product.

### SUMMARY OF THE INVENTION

In one broad form the invention provides a berley dispenser having:
a berley storage volume;
a dispenser that communicates the berley storage volume with the outside environment via at least one flow path,
   wherein the dispenser is selectively operable to cause at least one of:
opening of the at least one flow path;
closing of the at least one flow path, and
flow of berley along the at least one flow path from the berley storage volume to the outside environment.

The berley dispenser preferably includes a macerator within the berley storage volume. The macerator preferably comprises at least one rotating blade.

The dispenser may be operable to draw or allow fluid into the berley storage volume.

The dispenser may comprise at least one valve that is operable to open and close the at least one flow path.

In a preferred form the dispenser includes a fluid pump that introduces fluid into and/or withdraws fluid from the berley storage volume. The fluid pump may be a gas pump such as an air pump or a liquid pump, such as a water pump

In one form the dispenser comprises a valve and a fluid pump.

The valve may be a pressure operated valve that opens when the pressure differential across the valve exceeds a predetermined value.

In one form, in use, the berley storage volume is substantially sealed and the fluid pump is operable to introduce fluid into the berley storage volume to increase the pressure therein.

In a preferred form the dispenser comprises an air pump that is operable to pump fluid into the berley storage volume. A first pressure relief valve communicates with the berley storage volume and when the pressure in the berley storage volume caused by the air pump exceeds a pre-set value the first pressure relief valve opens and dispenses berley. The valve stays open until the pressure in the volume has reduced such that the first pressure relief valve closes.

The first pressure relief valve may be operable to open when the pressure in the berley storage volume below the environmental pressure by a pre-set amount, i.e. the first pressure relief valve opens to allow water to enter the berley storage volume. Alternatively, the first valve may only open when the pressure in the berley storage volume is greater than the environmental pressure.

A second pressure relief valve may be provided that only opens when the pressure in the berley storage volume is less than the environmental pressure by a pre-set amount.

The air pump may be operable to remove air from the berley storage volume so as to reduce pressure in the berley storage volume. This may be used to cause the first pressure relief valve to close or to cause the first or (if present) second pressure relief valve to open to allow water to enter the berley storage volume.

As an alternative, the fluid pump may be operable to pump water into the berley storage volume or a second fluid pump may be provided to do so.

Preferably a level sensor, such as a float, is used to turn off the fluid pump when the water level in the berley storage volume reaches a pre-set level.

In one form the berley storage volume comprises a tubular volume having first and second ends and there is at least one first or second pressure relief valve at or near the first one end of the volume. In use the berley storage volume is positioned so that the first end is below the second end. Pressure greater than the environment by a first set amount dispenses berley whilst pressure below environmental by a second set amount draws water into the volume.

### BRIEF DESCRIPTION OF THE DRAWINGS

FIG. 1 is a side cross sectional view of a berley dispenser according to a first embodiment of the invention.

FIG. 2 is a view from above of the lower cylinder of the berley dispenser of FIG. 1.

FIG. 3 is a view from above of the head unit of the berley dispenser of FIG. 1.

FIG. 4 is a view from below of the head unit of the berley dispenser of FIG. 1.

FIG. 5 is a side view of a removable and replaceable lower silicone seal that has an opening that only opens when under pressure

FIG. 6 is a side view of a silicone seal that seals between the head unit and the lower cylinder.

FIG. 7 is a side view of a lid or plug for main opening in the head unit.

FIG. 8 is a side view of the lower cylinder.

FIG. 9 is a side view of the head unit, when removed from the lower cylinder showing the inner attachments.

FIG. 10 is a view of remote control unit for the device.

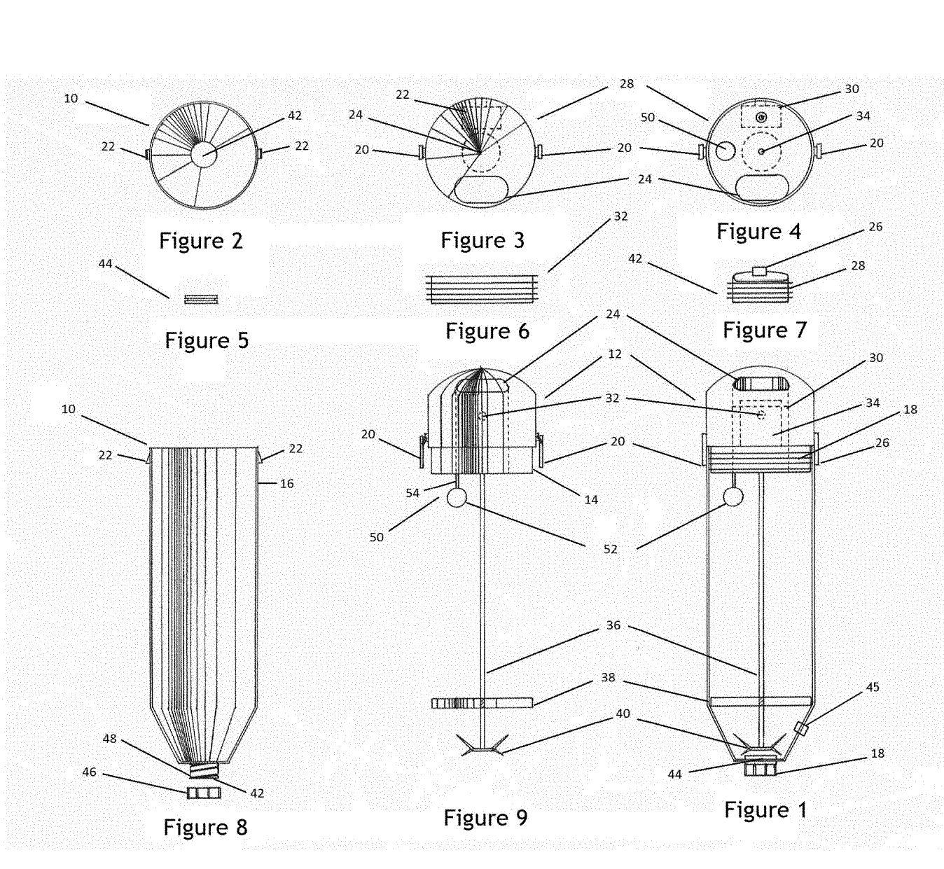

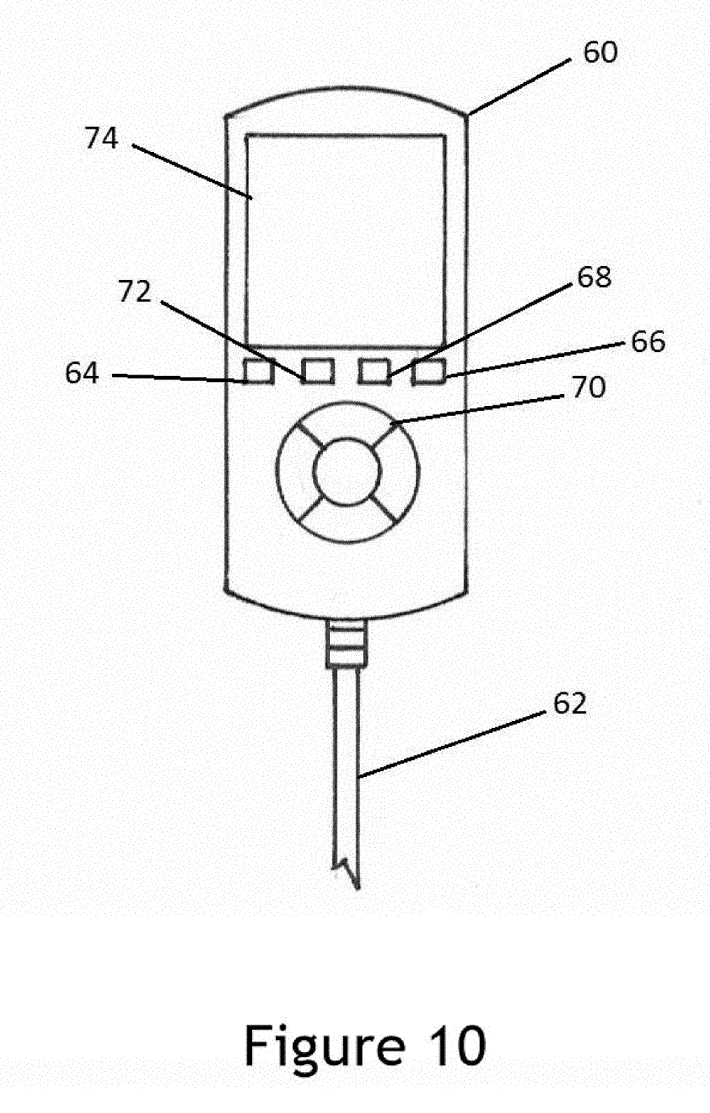

### DETAILED DESCRIPTION OF PREFERRED AND OTHER EMBODIMENTS

Referring to the figures there is shown a berley dispenser 8 comprising a lower cylinder 10, preferably made from a UV stable and salt tolerable material and an upper part, cap or head unit 12.

The head unit has a portion 14 sized to fit within the upper end 16 of cylinder 10 to close the cylinder 10. A suitable seal 18 between portion 14 and cylinder 10 provides a fluid tight seal.

The cylinder 10 and head unit 12 have clip parts 20 and 22 that cooperate to hold the cylinder 10 and head unit together.

The head unit 12 has an opening 24 that allows an operator to insert berley pieces or water into the unit. A plug 26 with a suitable seal 28 may be inserted into the opening 24 to seal the unit. The seal 28 is preferably removable and replaceable.

The head unit 12 includes an inflation and deflation air pump 30 that communicates with the outside environment via opening 32. The air pump may be operated to draw air into the cylinder 10 or expel air out of the cylinder.

The head unit 12 also includes a motor 34 having an output shaft 36 that extends to ward the base of the cylinder 10. A support bearing 38, which may be a plain bearing, is provided near the free end and one or more blades 40 are located at or near the free end of the shaft 36. Rotation of the motor and thus blades 40 will result in maceration of larger pieces of berley within the cylinder. Both the motor 34 and blades 40 are intended for high speed use to easily macerate the large pieces of berley into small pieces or even purified into liquid.

The base of the cylinder 10 is provided with an opening 42. The opening is closed by a pressure relief valve 44. In this embodiment the pressure relief valve 44 operates as a two way valve to allow a water/berley mix to exit the cylinder when the interior is at a pressure above the outside environment by a set threshold (dependent on the valve 44) and to also allow water to enter the cylinder when it at a pressure below the outside environment by a set threshold (again dependent on the valve 44). The valve may be a simple flexible membrane type with one or more slits that allows deflection of the membrane to open and close as needed. The membrane 44 is held in position by retaining ring 46 that screws onto threaded tubular extension 48.

Other types of valve 44 and valve arrangements may be used. As an alternative, valve 44 may be a one way valve that only allows fluid to exit the cylinder 10 and the dispenser 8 may be provided with a second valve 45 that allows fluid to enter the cylinder 10. The second valve 45 may be a one way valve that only allows fluid to enter the cylinder 10.

The head unit includes a level sensor 50, in this case a float 52 mounted on pivoting arm 54 that acts on a micro switch or similar (not shown) in the electric circuit for the air pump 30. When the air pump is operated to draw water into the cylinder 10 it will operate until the water level raises the flat 52 above a set level. When the air pump is operated to expel water/berley the level of the float 52 has no effect on operation of the air pump 30.

The head unit 12 preferably includes a switch mechanism (not shown) that prevents operation of one or both or the air pump 30 and motor 34 unless the plug 26 is located correctly in the opening 24. This may be by providing a magnetically operated reed or other micro switch in the head unit 12 and a magnet in the plug 26.

The unit may be provided with a remote control unit 60 that communicates with the air pump 30 and macerator motor 34 via cable 62. The cable may include tension members to allow the unit to be suspended from the cable or may be attached to a suitable support cable. Alternatively a separate support cable or similar may be provided.

The control unit preferably has control button 64 to cause the air pump 30 to draw air into the unit, control button 66 to cause air pump to expel air from the unit, control button 68 to turn macerator motor 34 on or off. These buttons may be incorporated on the head unit as duplicates or alternatives to the remote control.

A suitable battery may be provided within the head unit 12, the remote control 60, hardwired to a vessel via 12 volt deep cycle or boat battery or otherwise.

In use the head unit is mounted on the cylinder 10. The cylinder 10 may have water within but preferably not any solid berley pieces, as these may prevent full insertion of the macerator shaft 36 and blades 40. Once assembled berley pieces may be introduced into the unit via an opening 24. The plug 26 is inserted into the opening 24 and this allows the air pump 30 and macerator motor 34 to be operated.

The unit is placed into water with at least the lower end below the water surface. This may be in a bucket.

The air pump is operated to evacuate air from the unit. This reduces pressure and once there is sufficient pressure difference across the pressure relief valve 44, the valve 44 opens and water is drawn into the unit. The water level rises until the unit is at capacity, at which point level sensor 50 causes air pump 30 to turn off. At this point the lid can be opened and berley introduced.

The macerator may then be operated using button 68 until the berley has been macerated sufficiently. The cylinder 10 may be formed of a transparent plastics material or maybe provided with at least one transparent window so that a user may determine how well the berley has been macerated.

The control unit 60 may control the macerator whereby at least one of the rate at which the macerator operates, and the period of time for which the macerator operates is variable, whereby the particle size of the berley is variable.

After the berley has been macerated, the water and berley mixture is sealed in the unit and so the user is not exposed to any unpleasant smells. Once the source material has been placed inside the container, production of the water and berley mixture is substantially hands free, generally labour free and a “set and forget” process. Also, because the unit is sealed, the water and berley mixture cannot escape or leak out, so the unit may be carried within a boat or other vessel until it is desired to dispense the water and berley mixture. If desired the unit may be towed in the water from the boat but without dispensing the water and berley mixture.

When it is desired to dispense the water and berley mixture, the operator turns on the air pump 30 in the “eject” mode, using button 64. This causes the air pump 30 to draw or pump air into the unit and increase the pressure within. Once the pressure difference across the valve 44 exceeds a threshold, the valve opens and water and berley mixture exits the unit via opening 42 and valve 44. The volume dispensed and/or the rate of dispensing may be controlled by controlling the amount of air drawn or pumped into the unit 10 or the rate at which air is drawn or pumped into the unit 10. This may be achieved by providing a speed control dial 70 on the unit 10 or remote control unit whereby the user may control the speed of the air pump. The unit may also have a variable timer which turns off the air pump after a user set (but variable) period of operation.

When the user wishes to cease dispensing the water and berley mixture the user merely turns off air pump 30 and the valve 44 will close once the pressure differential reduces below a threshold at which the valve closes.

The user may operate the dispenser in at least the following modes:
i. Trolling mode (described above) which is a slow constant release of liquefied berley
ii. One off release and
iii. Timed release (i.e. every 5 minutes) with the specified release volume (i.e. 500 mil)

The one off release is by running the air pump for a short time.

Timed release control may be provided by the control unit having a mode in which it turns the air pump on and off periodically for. The on and off periods may be adjusted using one or two suitable buttons or dials (not shown) on the head unit and or remote control. Preferably the on and off periods are controllable independently.

Whilst the unit shown and described utilises a single two way valve that allows for fluid flow into and out of the unit, it will be appreciated that two separate one way vales may be used instead.

Unless the context clearly requires otherwise, throughout the description and any claims the words “comprise”, “comprising”, and the like are to be construed in an inclusive sense as opposed to an exclusive or exhaustive sense; that is to say, in the sense of “including, but not limited to”.

The features of the invention described or mentioned in this document may be combined in any combination of features where features are not mutually exclusive.

It will be apparent to those skilled in the art that many obvious modifications and variations may be made to the embodiments described herein without departing from the spirit or scope of the invention.

I claim:

1. A berley dispenser having:
a berley storage volume;
a dispenser that communicates the berley storage volume with the outside environment via at least one flow path,
wherein the dispenser is selectively operable to cause at least one of:
opening of the at least one flow path;
closing of the at least one flow path, and
flow of berley along the at least one flow path from the berley storage volume to the outside environment.

2. The berley dispenser of claim 1 including at least one fluid pump that introduces fluid into and/or withdraws fluid from the berley storage volume.

3. The berley dispenser of claim 2 wherein the at least one fluid pump is operable to pump or draw:
air only, water only, or both air and water;
out of, into, or both into and out of the berley storage volume.

4. The berley dispenser of claim 3 wherein, in use, the berley storage volume is substantially sealed and the at least one fluid pump is:
operable to introduce fluid into the berley storage volume to increase the pressure therein;
operable to remove fluid from the berley storage volume so as to reduce pressure therein, or
operable to introduce fluid into the berley storage volume to increase the pressure therein and remove fluid from the berley storage volume so as to reduce the pressure therein.

5. The berley dispenser of claim 4 further comprising at least one valve that is operable to open and close the at least one flow path.

6. The berley dispenser of claim 5 wherein the at least one valve opens when the pressure differential across the at least one valve exceeds a predetermined value.

7. The berley dispenser of claim 6 wherein the at least one valve opens when the pressure in the berley storage volume is greater than the environmental pressure by a first predetermined value.

8. The berley dispenser of claim 6 wherein the at least one valve opens when the pressure in the berley storage volume is below the environmental pressure by a second predetermined value.

9. The berley dispenser of claim 5 wherein the at least one valve comprises a second pressure relief valve and that only opens when the pressure in the berley storage volume is less than the environmental pressure by a second predetermined value.

10. The berley dispenser of claim 4 wherein the at least one fluid pump comprises an air pump.

11. The berley dispenser of claim 4 wherein the at least one fluid pump comprises a water pump.

12. The berley dispenser of claim 4 comprising a level sensor, wherein operation of the at least one fluid pump to pump or draw water into the berley storage volume ceases when the water level in the berley storage volume reaches a pre-set level.

13. The berley dispenser of claim 4 wherein, when the pressure in the berley storage volume is greater than the environment by a first set amount berley is dispensed whilst when the pressure in the berley storage volume is below environmental by a second set amount water is drawn into the volume.

14. The berley dispenser of claim 4 wherein the flow rate of the at least one fluid pump is variable and including a pump controller for controlling the at least one fluid pump whereby at least one of:
the rate at which fluid is introduced into the berley storage volume by the at least one fluid pump;
the rate at which fluid is withdrawn from the berley storage volume by the at least one fluid pump, and
the period of time for which the at least one fluid pump operates, is variable.

15. The berley dispenser of claim 4 including a macerator within the berley storage volume.

16. The berley dispenser of claim 15 including a macerator controller for controlling the macerator whereby at least one of:
the rate at which the macerator operates, and
the period of time for which the macerator operates, is variable,
whereby the particle size of the berley is variable.
